(19) United States
(12) Patent Application Publication
(10) Pub. No.: US 2009/0010673 A1
(43) Pub. Date: Jan. 8, 2009

(54) FILTER AND METHOD OF MANUFACTURING THE SAME

(75) Inventor: Kazuhiro Iida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 11/814,650

(22) PCT Filed: Jan. 25, 2006
(86) PCT No.: PCT/JP2006/301119

§ 371 Date: Aug. 30, 2007

(30) Foreign Application Priority Data
Jan. 25, 2005 (JP) 205-017394

(51) Int. Cl. G03G 21/20

(52) U.S. Cl. 399/93

(57) ABSTRACT

The present invention provides a filter structure manufacturable through fewer steps and at lower cost by using inexpensive materials and general techniques for processing while maintaining accuracy of the production of clearances that determines filtering performance and a method of manufacturing the filter structure. The filter structure according to the present invention comprises a base plate, a first intermediate layer, a second intermediate layer and a cover. The first intermediate layer has a first flow channel and a second flow channel with predetermined widths and depths, and the second intermediate layer has a third flow channel with a predetermined width and depth. The third flow channel communicates with the first flow channel and also with the second flow channel, and the maximum depth of the third flow channel is smaller than the minimum depths of the first flow channel and the second flow channel. Accordingly, the production accuracy for the clearances which determines the filter performance can be highly maintained by utilizing the thickness of the second intermediate layer.

### TECHNICAL FIELD

The present invention relates to a filter for separating plasma from cells and the like and to a method of manufacturing the same.

### BACKGROUND ART

In recent years, the “micro total analysis systems” which is means for analyzing a biogenic substance such as protein and a nucleic acid by utilizing a minute construction provided on a chip (Non-patent Document 1: Micro Total Analysis Systems 2002, Baba Y., Shoji, S., and van den Berg, A. eds. Kluwer Academic Press, London (2002)) have been developed. This technique requires only a very small amount of a sample to be used for the analysis, and it is also sufficient to use a small amount of a reagent. Furthermore, time required for the analysis itself is shortened, and so this is a technique fit to a purpose of obtaining a result of analysis in a short time. To be more specific, if the technique of the “micro total analysis systems” is utilized for an analysis in medical field such as a biochemical assay of blood, the analysis requires only a very small amount of blood so that it is less-invasive to a patient in terms of sampling blood. It is expected that, if a test result usable for diagnosing becomes promptly available, it will significantly contribute to increased efficiency of medical care of the patient.

In the case of the biochemical assay of blood, measurements are made for various concentrations contained in liquid components of blood, that is, the plasma. Prior to the assay, it is necessary to separate the plasma from a collected blood sample. Some filters have been invented in order to separate only the plasma, which is a test object of the “micro total analysis systems”, from the blood sample. In the case of filter separation of a soluble fraction such as a chemical component dissolved in a liquid from a liquid sample in which solid components are mixed, a dialysis membrane or a porous membrane is normally used. However, it has been difficult to fabricate a built-in thin film for functioning as the dialysis membrane or a porous membrane in a microscopic flow channel on a chip that is used for the “micro total analysis systems.”

Patent Document 1: JP 2000-262871 A discloses a filter composed of a flow channel and a porous body which are formed in integral shape by using a photo-curing resin. The filter disclosed in Patent Document 1: JP 2000-262871 A realizes a filtering function by providing a barrier wall halfway through one flow channel and forming a large number of grooves on the barrier wall. Furthermore, separation area is increased by forming the barrier wall along in a longitudinal direction of the flow channel.

Patent Document 2: JP 2002-239317 A discloses a filter in which micro pillars are arranged halfway through one flow channel instead of the barrier wall so as to perform the filtration by utilizing mutual clearances among the pillars. As for the filter of Patent Document 2: JP 2002-239317 A, it utilizes a base plate of silicon or the like of higher mechanical strength than a resin and thereby utilizes a technique for fine processing such as dry etching so as to realize a filter having further micro filtration clearances and higher mechanical strength.

Patent Document 3: JP 2004-42012 A describes a filter for performing the filtration by utilizing the clearances between a bank-shape barrier wall provided between two flow channels formed on the base plate and a cover covering the base plate. The filter of Patent Document 3 does not utilize microstructures such as a large number of grooves and pillars so that still higher mechanical strength can be kept. Furthermore, a barrier filter portion is composed of the two flow channels, and so it is possible to improve filtration efficiency by utilizing counter flows between the two flow channels. Especially, the bank-shape barrier wall itself provided between two flow channels can be produced at a high yield rate because of its simple structure unlike the microstructures such as the large number of grooves and pillars.

Non-patent Document 1: Micro Total Analysis Systems 2002, Baba Y., Shoji, S., and van den Berg, A. eds. Kluwer Academic Press, London (2002)

Patent Document 1: JP 2000-262871 A

Patent Document 2: JP 2002-239317 A

Patent Document 3: JP 2004-42012 A

### DISCLOSURE OF THE INVENTION

### Problem to be Solved by the Invention

However, the filter disclosed in Patent Document 3 still has some problems to be further improved.

The biggest problem in attempting utilization in a wider range is that manufacturing unit cost of the filter disclosed by JP 2004-42012 A (Patent Document 3) becomes relatively high. A chip used for examination of the samples taken from each of the patients such as a clinical test is disposable in principle. Therefore, it is desirable that the filter be as inexpensively manufacturable as possible. A main factor behind the relatively high manufacturing unit cost is that a further complicated manufacturing process is required for formation of the bank-shape barrier wall provided between the two flow channels, which barrier is a main part of the filter structure disclosed by Patent Document 3. To be more specific, the filter for separating the plasma from the blood sample requires “micro clearances” which do not pass blood cells as solid components but only pass liquid components. In the case of the filter disclosed by JP 2004-42012 A (Patent Document 3), the clearances between the bank-shape barrier wall provided between the two flow channels and the cover are equivalent to the micro clearances. The complicated process was required when manufacturing the micro clearances with high accuracy. In the case of plasma separation for instance, a clearance size of the micro clearance is rendered smaller than a blood cell size (minimum diameter of a red blood cell is 3 μm for instance) so as to fulfill a function as the filter. If the clearance size of the micro clearance is too small, the filtration efficiency lowers and it is no longer practical. Considering the two constraints, the clearance size of the micro clearance is designed so that it becomes as large a size as possible while maintaining the function as the filter. It is necessary to manufacture this designed size with high accuracy (height (clearance height) of 1.8 μm±0.1 μm and width (clearance width) of 3.6 μm±0.1 μm or so for instance).

In the case of manufacturing the micro clearances by processing the base plate having strength such as silicon, expensive manufacturing facilities such as a gas etching apparatus are used, and an uneven structure of a desired depth is formed in addition. Therefore, it has been necessary to go through multi-step process. As for the micro clearances, it is also possible, as with the filter of Patent Document 1, to form and manufacture them by a step exposure method through utilization of a photosensitive molding material such as the photo-curing resin and application of a photolithographic approach. In that case, exposure having a high position resolution is required, and so it is necessary to use an expensive exposure apparatus, such as a stepper. To be more specific, it is difficult for a general contact exposure apparatus to manufacture a structure of 10 μm or less with high accuracy. JP 2004-286449 A (Patent Document 4) discloses a method of integrally molding the flow channels by the photolithographic approach through utilization of a thick film resist, which requires a high size resolution so that an expensive exposure apparatus utilizing a short wavelength excimer laser is necessary. JP 2004-148519 A (Patent Document 5) discloses a method of manufacturing a chip wherein a mold having a minute flow channel shape is manufactured and injection molding is performed by utilizing this mold of high machining accuracy. Even if the processing accuracy of the mold itself is high, however, it is difficult for a general injection molding apparatus to faithfully transfer a minute structure of 10 μm or less. For that reason, a particular kind of injection molding apparatus is essential in manufacturing an injection-molded element having submicron size accuracy required for a plasma separation filter. And that apparatus cost is high.

An object of the present invention is to provide a filter structure manufacturable through fewer steps and at lower cost by using inexpensive materials and general processing techniques and a method of manufacturing the filter structure.

### Means for Solving Problem

The filter according to a first aspect of the present invention is

a filter comprising:

a base plate;

a first intermediate layer;

a second intermediate layer; and

a cover,

wherein

the first intermediate layer has a first flow channel and a second flow channel with predetermined widths and depths;

the second intermediate layer has a third flow channel with a predetermined width and depth;

the third flow channel communicates with the first flow channel and the second flow channel; and

the maximum depth of the third flow channel is smaller than the minimum depths of the first flow channel and the second flow channel. In that case, the first flow channel and the second flow channel are placed to run side by side; and

the third flow channel is placed to run side by side with the first flow channel and the second flow channel which run side by side with each other.

It is desirable that the filter according to the first aspect of the present invention have such a constitution wherein

either both or one of the first intermediate layer and the second intermediate layer is formed out of a photosensitive molding material selected from the group consisting of a photoresist, a photo-curing resin, photosensitive glass and photosensitive polyimide.

A filter according to a second aspect of the present invention is

a filter comprising:

a base plate;

an intermediate layer; and

a cover,

wherein

the base plate has a first flow channel and a second flow channel with predetermined widths and depths;

the intermediate layer has a third flow channel with a predetermined width and depth;

the third flow channel communicates with the first flow channel and the second flow channel; and

the maximum depth of the third flow channel is smaller than the minimum depths of the first flow channel and the second flow channel. In that case, the first flow channel and the second flow channel are placed to run side by side; and

the third flow channel is placed to run side by side with the first flow channel and the second flow channel which run side by side with each other.

It is desirable that the filter according to the second aspect of the present invention have such a constitution wherein:

the intermediate layer is formed out of a photosensitive molding material selected from the group consisting of a photoresist, a photo-curing resin, photosensitive glass and photosensitive polyimide.

The above-mentioned filter according to the first aspect of the present invention and filter according to the second aspect of the present invention employ such a structure of a joining section

wherein

the maximum width of a communicating portion of the third flow channel and the first flow channel is smaller than the minimum width of the first flow channel; and

the maximum width of the communicating portion of the third flow channel and the second flow channel is smaller than the minimum width of the second flow channel.

In association with the invention of the filter according to the first aspect of the present invention and the invention of the filter according to the second aspect of the present invention,

the present invention provides, as an invention of a chip utilized in the “micro total analysis systems,”

a chip comprising at least one filter as its component,

wherein the above-mentioned filter according to the first aspect of the present invention or filter according to the second aspect of the present invention is used as at least one or more of the filters. The present invention further provides, as an invention of an apparatus composing the “micro total analysis systems” itself,

an apparatus comprising at least one filter as its component,

wherein the above-mentioned filter according to the first aspect of the present invention or filter according to the second aspect of the present invention is used as at least one or more of the filters.

A filter according to a third aspect of the present invention is

a filter comprising:

a base plate;

a first intermediate layer;

a second intermediate layer; and

a cover,

wherein

the first intermediate layer has a first flow channel with a predetermined width and depth;

the second intermediate layer has a second flow channel with a predetermined width and depth;

the second flow channel communicates with the first flow channel; and

the maximum width of a communicating portion of the first flow channel and the second flow channel is smaller than the minimum width of the first flow channel and is also smaller than the minimum width of the second flow channel. In that case, the first flow channel and the second flow channel are placed to run side by side.

It is desirable that the filter according to the third aspect of the present invention have a constitution wherein:

either both or one of the first intermediate layer and second intermediate layer is formed out of a photosensitive molding material selected from the group consisting of a photoresist, a photo-curing resin, photosensitive glass and photosensitive polyimide.

A filter according to a fourth aspect of the present invention is

a filter comprising:

a base plate;

an intermediate layer; and

a cover,

wherein

the base plate has a first flow channel with a predetermined width and depth;

the intermediate layer has a second flow channel with a predetermined width and depth;

the second flow channel communicates with the first flow channel; and

the maximum width of a communicating portion of the first flow channel and the second flow channel is smaller than the minimum width of the first flow channel and is also smaller than the minimum width of the second flow channel. In that case, the first flow channel and the second flow channel are placed to run side by side.

It is desirable that the filter according to the fourth aspect of the present invention have a constitution wherein

the intermediate layer is formed out of a photosensitive molding material selected from the group consisting of a photoresist, a photo-curing resin, photosensitive glass and photosensitive polyimide.

In association with the invention of the filter according to the third aspect of the present invention and the invention of the filter according to the fourth aspect of the present invention,

the present invention provides, as an invention of a chip utilized in the “micro total analysis systems,”

a chip comprising at least one filter as its component,

wherein the above-mentioned filter according to the third aspect of the present invention or filter according to the fourth aspect of the present invention is used as at least one or more of the filters. The present invention further provides, as an invention of an apparatus composing the “micro total analysis systems” itself,

an apparatus comprising at least one filter as its component,

wherein the above-mentioned filter according to the third aspect of the present invention and filter according to the fourth aspect of the present invention is used as at least one or more of the filters.

The present invention further provides an invention of a method of manufacturing a filter preferably applicable to manufacturing of the above-mentioned filter according to the first aspect of the present invention and filter-according to the third aspect of the present invention.

To be more specific, the invention of the method of manufacturing the filters according to the first aspect and the third aspect of the present invention is:

a method of manufacturing a filter composed of a base plate, a first intermediate layer made of a first molding material, a second intermediate layer made of a second molding material, and a cover, the method comprising the steps of:

applying the first molding material on the base plate;

forming a flow channel on the first molding material;

applying the second molding material on the cover;

forming the flow channel on the second molding material; and

joining a surface of the first molding material having the flow channel formed thereon to the surface of the second molding material having the flow channel formed thereon.

In that case,

It is desirable, in either both or one of the steps of forming the flow channel on the first molding material and of forming the flow channel on the second molding material,

a photosensitive molding material is employed as the first molding material or the second molding material, and

said step comprises the steps of exposing and developing the photosensitive molding material.

The present invention further provides an invention of a method of manufacturing a filter preferably applicable to manufacturing of the above-mentioned filter according to the second aspect of the present invention and filter according to the fourth aspect of the present invention.

To be more specific, the invention of the method of manufacturing the filters according to the second aspect and the fourth aspect of the present invention is:

a method of manufacturing a filter composed of a base plate made of a plastic material, an intermediate layer made of a molding material, and a cover, the method comprising the steps of:

forming a flow channel on the base plate made of a plastic material by using a mold;

applying the molding material on the cover;

forming a flow channel on the molding material; and

joining a surface of the base plate having the flow channel formed thereon to the surface of the molding material having the flow channel formed thereon.

In that case,

it is desirable, in the step of forming a flow channel on the molding material,

a photosensitive molding material is employed as the first molding material or the second molding material, and

said step comprises the steps of exposing and developing the photosensitive molding material.

In the method of manufacturing a filter having the above-mentioned constitution according to the present invention,

It may be preferred to employ such a constitution that the step of joining comprises the steps of:

performing a surface treatment operation selected from the group consisting of UV-ozone ashing and oxygen plasma ashing to joined planes to be joined before joining them with each other so as to reform the surfaces of the planes to be joined; and

performing the joining by utilizing the reformed surfaces.

### EFFECT OF THE INVENTION

A first advantage is that it is possible to manufacture the filter through fewer steps and at lower cost by using inexpensive materials and general processing techniques.

A second advantage is that it is possible to manufacture the filter for realizing multi-step filtration through fewer steps and at lower cost by using inexpensive materials and general processing techniques.

### BRIEF DESCRIPTION OF THE DRAWINGS

FIG. 1 are a plan view and a sectional view schematically showing a structure of a conventional filter;

FIG. 2 are drawings of process flow illustrating a method of manufacturing a conventional filter;

FIG. 3 is a sectional view schematically showing the filter structure according to a first exemplary embodiment of the present invention;

FIG. 4 are drawings of process flow showing the method of manufacturing the filter structure according to the first exemplary embodiment of the present invention;

FIG. 5 is a sectional view schematically showing the filter structure according to a second exemplary embodiment of the present invention;

FIG. 6 are drawings of process flow showing the method of manufacturing the filter structure according to the second exemplary embodiment of the present invention;

FIG. 7 is a sectional view schematically showing the filter structure according to a third exemplary embodiment of the present invention;

FIG. 8 is a sectional view schematically showing the filter structure according to a fourth exemplary embodiment of the present invention;

FIG. 9 are drawings of process flow showing another method of manufacturing the filter structure according to the first exemplary embodiment of the present invention;

FIG. 10 is a sectional view schematically showing another exemplary embodiment of the filter structure according to the second exemplary embodiment of the present invention;

FIG. 11 are plan views schematically showing the filter structure according to the first exemplary embodiment of the present invention;

FIG. 12 is an image print-out showing a microscopic observation result of the filter structure manufactured in the first exemplary embodiment according to the present invention;

FIG. 13 is an image print-out showing the microscopic observation result indicating a state where water was introduced to one of two flow channels formed in a first intermediate layer in the filter structure manufactured in the first exemplary embodiment according to the present invention; and

FIG. 14 is an image print-out showing the microscopic observation result indicating a state where water containing a surfactant was introduced to one of two flow channels formed in a first intermediate layer in the filter structure manufactured in the first exemplary embodiment according to the present invention.

The symbols shown in the drawings have the following meanings respectively.
001 . . . Sample inlet
002 . . . Liquid reservoir
003 . . . Liquid reservoir
004 . . . Liquid reservoir
005 . . . Induction flow channel
006 . . . Conventional filter
100 . . . Base plate
103 . . . Cover
110 . . . Flowchannel
111 . . . Bank portion (barrier wall between the flow channels)
112 . . . Vertical clearance (clearance height)
113 . . . Horizontal clearance (clearance width)
114 . . . Upper flow channel
120 . . . First intermediate layer
121 . . . Second intermediate layer
200 . . . Oxide film
210 . . . Resist
300 . . . Surface plate

### BEST MODE FOR CARRYING OUT THE INVENTION

The filter of the present invention comprises:

a base plate;

a first intermediate layer;

a second intermediate layer; and

a cover,

wherein

the first intermediate layer has a first flow channel and a second flow channel;

the second intermediate layer has a third flow channel;

the third flow channel communicates with the first flow channel and the second flow channel;

the maximum depth of the third flow channel is smaller than the minimum depths of the first flow channel and the second flow channel; and

consequently there is no need to build the flow channels in the base plate and the cove by digging them, and thus thickness of the base plate and the cover can be minimum so that the base plate and the cover can be formed out of an inexpensive resin film and the like, which allows manufacturing cost to be lowered.

Further, in said filter of the present invention,

as the first flow channel, second flow channel and third flow channel run side by side with each other; and

the communicating portion of the first flow channel and the third flow channel and the communicating portion of the second flow channel and the third flow channel can be set wide to improve filtration efficiency so that manufacturing cost can be consequently lowered by reducing actual area of the filter to be built therein.

In said filter of the present invention,

either both or one of the first intermediate layer and the second intermediate layer is made of a photosensitive molding material including a photoresist, a photo-curing resin, photosensitive glass and photosensitive polyimide so that a flow channel can be formed through a simple process by using photo-lithography, and use of such an inexpensive photosensitive molding material can provide cost-down for manufacturing.

Furthermore, the filter of the present invention comprises

a base plate;

an intermediate layer; and

a cover,

wherein

the base plate has a first flow channel and a second flow channel;

the intermediate layer has a third flow channel;

the third flow channel communicates with the first flow channel and the second flow channel; and

the maximum depth of the third flow channel is smaller than the minimum depths of the first flow channel and the second flow channel; and

consequently there is no need to build the flow channels in the cover by digging it, and thus thickness of the cover can be minimum so that the cover can be formed out of an inexpensive resin film and the like, which allows manufacturing cost to be lowered.

Further, in said filter of the present invention,

as the first flow channel, second flow channel and third flow channel run side by side with each other; and

the communicating portion of the first flow channel and the third flow channel and the communicating portion of the second flow channel and the third flow channel can be set wide to improve filtration efficiency so that manufacturing cost can be consequently lowered by reducing actual area of the filter to be built therein.

In said filter of the present invention,

either both or one of the first intermediate layer and the second intermediate layer is made of a photosensitive molding material including a photoresist, a photo-curing resin, photosensitive glass and photosensitive polyimide so that a flow channel can be formed through a simple process by using photo-lithography, and use of such an inexpensive photosensitive molding material can provide cost-down for manufacturing.

Furthermore, in the filter of the present invention,

as the maximum width of the communicating portion of the third flow channel and the first flow channel and the maximum width of the communicating portion of the third flow channel and the second flow channel are smaller than the minimum width of the first flow channel and the minimum width of the second flow channel;

the communicating portion of the third flow channel and the first flow channel and the communicating portion of the third flow channel and the second flow channel function as the filters respectively so that the filter capable of multi-step filtration can be manufactured at low cost.

In addition, the filter of the present invention comprises:

a base plate;

a first intermediate layer;

a second intermediate layer; and

a cover,

wherein

the first intermediate layer has a first flow channel;

the second intermediate layer has a second flow channel;

the second flow channel communicates with the first flow channel; and

the maximum width of the communicating portion of the first flow channel and the second flow channel is smaller than the minimum width of the first flow channel and the minimum width of the second flow channel; and

consequently the number of the flow channels built in the first intermediate layer decreases, and actual area of the filter to be built therein can be reduced so that manufacturing cost of chips comprising the filter can be lowered.

Further, in said filter of the present invention,

as the first flow channel and the second flow channel run side by side,

the communicating portion of the channels can be set wide to improve filtration efficiency so that manufacturing cost can be consequently lowered by reducing actual area of the filter to be built therein.

In said filter of the present invention,

either both or one of the first intermediate layer and the second intermediate layer is made of a photosensitive molding material including a photoresist, a photo-curing resin, photosensitive glass and photosensitive polyimide so that a flow channel can be formed through a simple process by using photo-lithography, and use of such an inexpensive photosensitive molding material can provide cost-down for manufacturing.

The present invention provides a filter wherein:

either both or one of the first intermediate layer and the second intermediate layer is composed of a photosensitive molding material including a photoresist, a photo-curing resin, photosensitive glass and photosensitive polyimide so that a flow channel can be formed through a simple process by using optical lithography, and manufacturing cost can be lowered by utilizing an inexpensive photosensitive molding material.

Further, the filter of the present invention comprises:

a base plate;

an intermediate layer; and

a cover,

wherein

the base plate has a first flow channel;

the intermediate layer has a second flow channel;

the second flow channel communicates with the first flow channel; and

the maximum width of the communicating portion of the first flow channel and the second flow channel is smaller than the minimum width of the first flow channel and the minimum width of the second flow channel; and

consequently the number of the flow channels built in the intermediate layer decreases, and actual area of the filter to be built therein can be reduced so that manufacturing cost of chips comprising the filter can be lowered.

Further, in said filter of the present invention,

as the first flow channel and the second flow channel run side by side,

the communicating portion of the channels can be set wide to improve filtration efficiency so that manufacturing cost can be consequently lowered by reducing actual area of the filter to be built therein.

The method of manufacturing a filter of the present invention comprises the steps of:

applying a first molding material on a base plate;

forming a flow channel on the first molding material;

applying a second molding material on a cover;

forming the flow channel on the second molding material; and

joining a surface of the first molding material having the flow channel formed thereon to the surface of the second molding material having the flow channel formed thereon; and

thus it is possible, on position alignment in joining, to freely select a positional relation between the flow channel formed on the first molding material and the flow channel formed on the second molding material. Therefore, it is possible to manufacture the filters of different filtration sizes with the same mask, which allows manufacturing cost to be lowered especially in the case of manufacturing various types of filters.

Further, in said method of manufacturing a filter of the present invention,

either both or one of the steps of forming the flow channel on the first molding material and forming the flow channel on the second molding material comprise the steps of exposing and developing; and

thus the flow channel can be formed by general manufacturing facilities without using an expensive apparatus for dry etching or the like so that manufacturing cost can be lowered.

Furthermore, the method of manufacturing a filter of the present invention comprises the steps of:

forming a flow channel on a base plate made of a plastic material by using a mold;

applying a molding material on a cover;

forming a flow channel on the molding material; and

joining a surface of the base plate having the flow channel formed thereon to the surface of the molding material having the flow channel formed thereon; and

thus it is possible to form the base plate and the flow channel on the base plate by low-cost manufacturing techniques including injection molding and embossing so that manufacturing cost can be lowered.

Further, in said method of manufacturing a filter of the present invention,

the step of forming the flow channel on the molding material comprises the steps of exposing and developing; and

thus the flow channel can be formed by general manufacturing facilities without using an expensive apparatus for dry etching or the like so that manufacturing cost can be lowered.

Furthermore, in said method of manufacturing a filter of the present invention,

the step of joining comprises the steps of:

performing a surface treatment operation including UV-ozone ashing and oxygen plasma ashing so as to reform the surfaces of the planes to be joined; and

performing the joining them with each other; and

thus there is no need to attach a binding material after patterning or add heat on joining, and manufacturing cost can be lowered because the filter can be manufactured by using inexpensive manufacturing apparatuses such as a UV-ozone ashing apparatus and an oxygen plasma ashing apparatus.

Exemplary embodiments of the present invention will be explained further in detail with reference to the drawings.

First, problems of the filter of the conventional example will be more concretely described, and then the filter of the present invention will be explained as to its constitution and advantages by taking the exemplary embodiments.

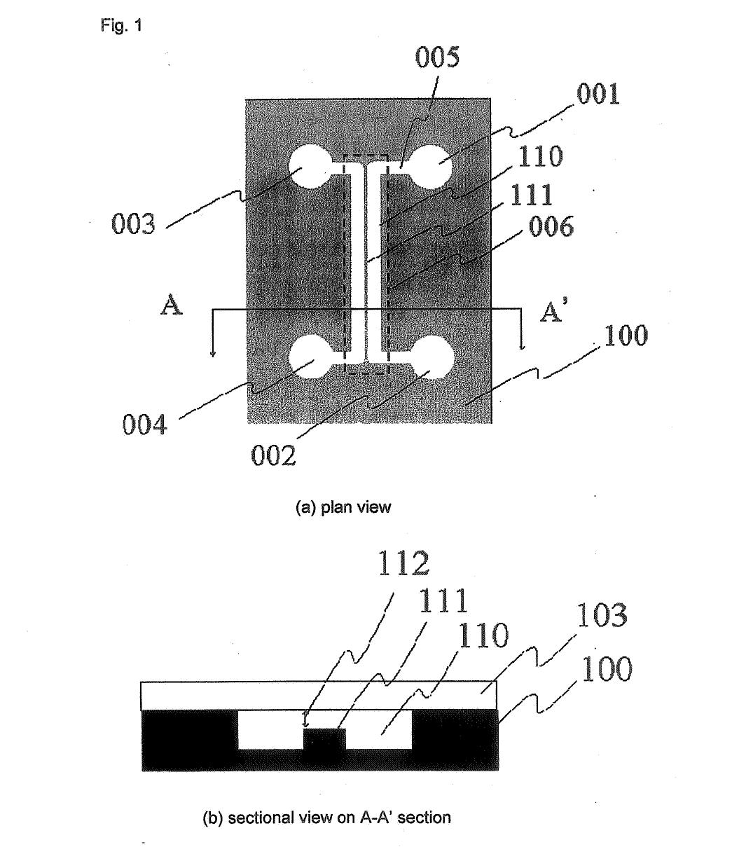

FIG. 1 show an example of a structure of a chip described in Patent Document 3 in which a conventional filter is built. FIG. 1(a) is a plan view, and FIG. 1(b) is a sectional view at A to A′ on the plan view. In FIG. 1(a), an uncolored portion is a groove or a concavity engraved on a base plate 100. A conventional filter 006 refers to a rectangular area surrounded by a dotted line on the plan view of FIG. 1(a), which is used in combination with other members such as an induction flow channel 005, liquid reservoirs 002 to 004 and a sample inlet 001 formed on the chip. This chip is used as follows. A reagent for coloring in reaction to a plasma component such as blood sugar is set in the liquid reservoir 004 in advance. If blood is introduced into the sample inlet 001, the blood flows toward the liquid reservoir 002 and fills the flow channel on the right side. If a buffer is introduced into the liquid reservoir 003, the plasma is extracted to the flow channel on the other side through a barrier wall 111, and the buffer containing the blood sugar reaches the liquid reservoir 004, which initiates coloring. Thus, this resulted coloring is optically measured to estimate blood glucose concentration.

A conventional filter 006 is composed of two flow channels 110 running side by side that are built in the base plate 100 by digging and, the barrier wall 111 for separating them, a cover 103 for covering the base plate and a vertical clearance 112 between the upper end of the barrier wall 111 and the cover 103. As the material for The base plate 100 and cover 103, a hard material having a small thermal expansion coefficient and easy to work upon, such as silicon, quartz, glass, a hard resin (polycarbonate, acrylic, epoxy, polystyrene or the like) or a metal (gold, platinum, stainless, aluminum alloy, brass or the like) is used. The barrier wall 111 is formed to be slightly depressed from the rest of the upper end of the base plate so that the vertical clearance 112 equivalent to the depressed portion is formed between the barrier wall 111 and the cover 103. A filtering function is realized because an object larger than the vertical clearance 112 cannot move from one flow channel 110 to the other flow channel 110 while an object smaller than the vertical clearance 112 can move to the other flow channel 110.

The width and depth of the flow channel 110, width of the barrier wall 111 and size of the vertical clearance 112 are selected according to the size of a component of the sample to be separated. In the case of plasma separation, the width of the flow channel 110 is set about 50 to 100 μm, the depth is set about 20 to 50 μm, and the width of the barrier wall 111 is set about 10 to 50 μm. The vertical clearance 112 is limited to 1.8 μm in order to block passing of a red blood cell having a disk-like shape of about 8-μm diameter and about 3-μm width and allow passing-through of liquid components. This is the size of the vertical clearance 112 selected to pass as large amounts of liquid components as possible while the red blood cell cannot pass through the vertical clearance 112 even if it is deformed. Therefore, the size thereof cannot be too large or too small. For that reason, it is necessary to shape the depression from the upper end of the base plate with accuracy of ±100 nm at the maximum.

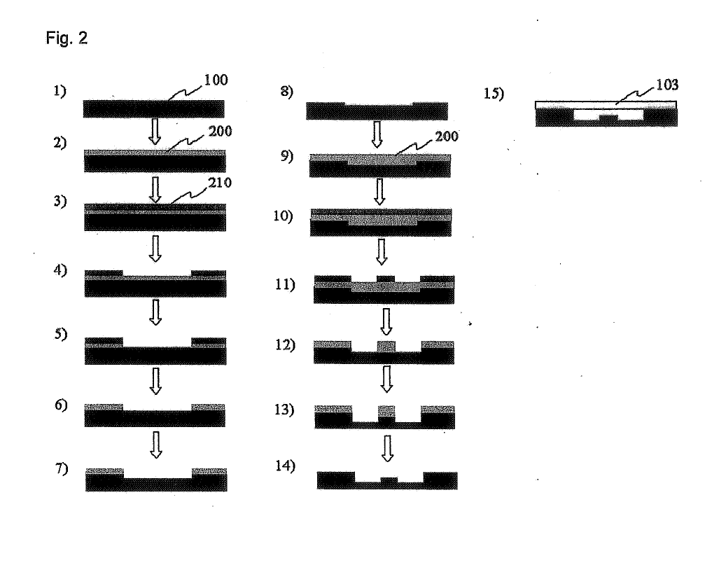

It is difficult to stably realize such accuracy by a processing method such as wet etching, and a yield becomes very low in that case. For that reason, the filter is processed by dry etching under present circumstances. To make the conventional filter 006 up, at least fifteen steps of process shown in FIG. 2 are required. The process is explained in the case of utilizing the base plate 100 made of silicon and the cover 103 made of Pyrex:

The process comprises the following steps of:

1) at first, cleaning the surface of the silicon base plate;

2) providing an oxide film 200 of 200 nm or so by a method of thermal oxidation or the like, which oxide film is used in a step of partial etching the portion corresponding to the depression of the barrier wall 111;

3) coating the surface of the oxide film with a photoresist 210 for patterning by several μm, and then prebaking it;

4) exposing a part of the photoresist by using a photomask or the like, and then developing so as to expose a part of the oxide film.

5) etching the oxide film with fluorinated acid to expose a silicon surface;

6) Next, eliminating the photomask by acetone cleaning or the like;

7) removing the exposed silicon surface just by 1.8-μm thickness by dry etching;

8) eliminating the oxide film with the fluorinated acid;

9) provide the oxide film 200 by 200 nm or so by using similar method to that used in the step 2), which oxide film is used in the step of partial etching the portion for the flow channel 110;

10) coating the photoresist in the same manner as that of the aforementioned step;

11) patterning the portion for the flow channel 110 to expose a part of the oxide film 200;

12) eliminating the oxide film of the exposed portion by etching it with the fluorinated acid so as to expose the silicon surface;

13) eliminating the photoresist, and then dry-etching or wet-etching the exposed silicon surface to form the flow channel 110;

14) removing the remaining oxide film with the fluorinated acid; and

15) lastly, electrostatically joining the cover 103 to the base plate surface.

Thus, the processing method utilizing the dry etching requires so many steps of process, and a dry etching apparatus itself is expensive so that the unit cost of production of the filter becomes high.

An exemplary embodiment of the present invention illustrated below solves this problem by changing the structure of the filter and manufacturing process thereof.

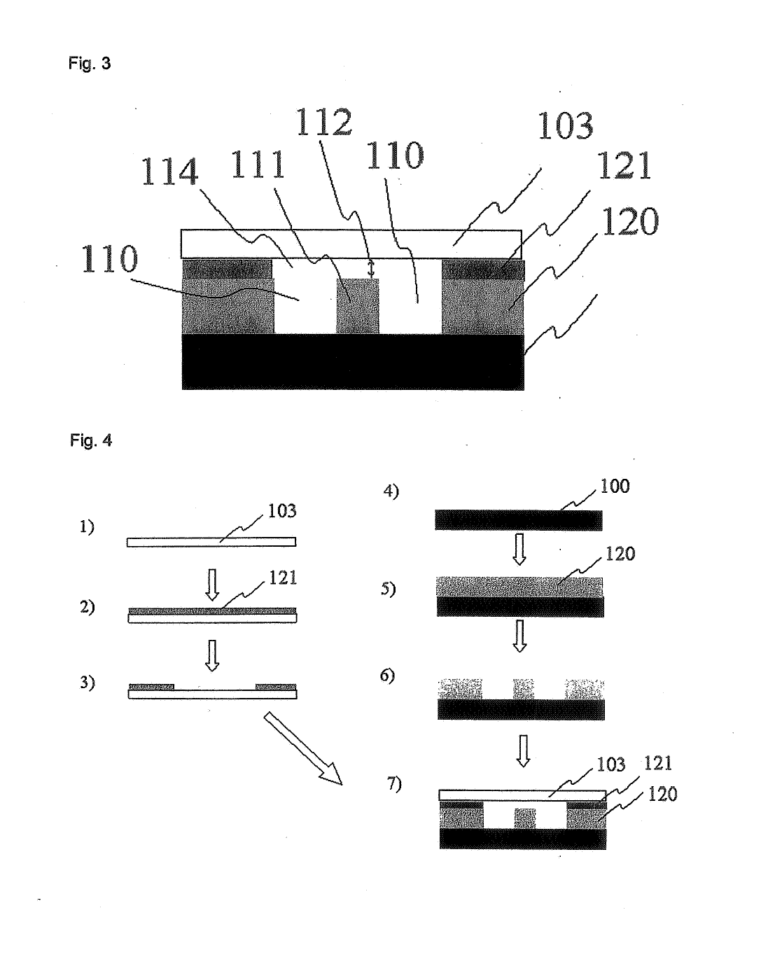

FIG. 3 is a sectional view showing the first exemplary embodiment of the present invention. The filter of the first exemplary embodiment of the present invention is composed of the base plate 100, a first intermediate layer 120 provided on the base plate 100, a second intermediate layer 121 provided on the first intermediate layer 120 and the cover 103. The flow channels 110 are formed as two grooves where a part of the first intermediate layer 120 is eliminated by patterning, and the barrier wall 111 is formed as a part of the first intermediate layer 120 remaining without being eliminated between the two flow channels 110. In the second intermediate layer 121, an upper flow channel 114 is formed by selective eliminating by patterning. The vertical clearance 112 is formed as a clearance between the upper end of the barrier wall 111 and the cover 103 so that the size thereof is equal to the thickness of the second intermediate layer 121.

In the first exemplary embodiment of the present invention shown in FIG. 3, the filtering function thereof is attained by constituting the clearance between the upper end of the barrier wall 111 and the cover 103 so that a subject to be filtered out cannot pass. On the other hand, a soluble component dissolved in the liquid component passes through the third flow channel, that is, the clearance between the upper end of the barrier wall 111 and the cover 103 so as to migrate from the first flow channel to the second flow channel for instance. Therefore, h; the vertical clearance 112 between the upper end of the barrier wall 111 and the cover 103 is selected to satisfy at least L≧W≧T>h as to an overall size; L (length), W (width) and thickness (T) (provided L≧W≧T) of the subject to be filtered out. For instance, in the case where the subject to be filtered out is deformable like the red blood cell, ;h; the vertical clearance 112 is selected to satisfy L≧W≧T>S>h as to the minimum thickness (S) of the overall size after deformation. It is desirable that the width (W2) of the upper end of the barrier wall 111 be selected within the range of W2≧h as to the vertical clearance 112; h in consideration of machining accuracy.

On the other hand, the liquid component passes through the third flow channel, that is, the clearance between the upper end of the barrier wall 111 and the cover 103, for instance, with use of a capillary phenomenon, and thus it is desirable that an index of wettability of the liquid component against the upper end surface of the barrier wall 111, that is, a contact angle θ1 be at least 90°>θ1, typically, in the range of 70°≧θ1. Similarly, as to the backside of the cover 103 for contacting the liquid component, the index of wettability of the liquid component against the backside of the cover 103, that is, a contact angle θ2 be at least 90°>θ2, typically, in the range of 70°≧θ2. In other words, as for the material of the first intermediate layer 120 composing the upper end surface of the barrier wall 111, it is possible to preferably utilize a material of which index of wettability to the liquid component, that is, the contact angle θ1 satisfies the aforementioned condition. As for the material comprising the backside of the cover 103, it is possible to preferably utilize a material of which index of wettability to the liquid component, that is, the contact angle θ2 satisfies the condition described above.

To be more specific, the filter of the first exemplary embodiment of the present invention is different from the conventional filter 006 in that it comprises the first intermediate layer 120 and the second intermediate layer 121 and that the accuracy of the vertical clearance 112 is decided by “film thickness accuracy” of the second intermediate layer 121.

The first intermediate layer 120 and the second intermediate layer 121 are respectively formed out of materials suited to patterning, such as a photoresist (e.g. an epoxy resin based photoresist including novolac type, a synthetic rubber based photoresist including polyisoprene type), a photo-curing resin, photosensitive polyimide and photosensitive glass, and out of soft materials having a small thermal expansion coefficient (e.g. polydimethylsiloxane rubber). The material comprising the first intermediate layer 120 and the second intermediate layer 121 may be either one of those materials for patterning or a combination of different kinds thereof. The base plate 100 and the cover 103 may be made of the same material as those used in the conventional filter 006 or of a low-cost material such as the resin film.

The second intermediate layer 121 can be formed on the cover 103 by a formation technique of high film thickness machining accuracy, such as spin coating. In the case where the film thickness of the second intermediate layer 121 is set 1.8 μm, an in-plane deviation of thickness can be 20 nm on average and 80 nm or less at the maximum when the formation on a disk-like base plate of 10-cm diameter is made by the spin coating so that high accuracy for the vertical clearance 112 can be realized.

FIG. 4 are steps-flow drawings illustrating the process for realizing the first exemplary embodiment of the present invention. The number of steps of process has decreased by half from 15 to 7 in comparison with the steps of the conventional process shown in FIG. 2. The process shown in FIG. 4 comprises the following steps of:

1) at first, cleaning the cover;

2) forming a photosensitive material, such as a novolac type photoresist, used to form the second intermediate layer 121 on the surface of the cover by spin coating.

3) exposing the filter portion of the photosensitive material by using the photomask or the like, and then developing to eliminate the portion.

4) in parallel, cleaning the base plate 100.

5) forming the photosensitive material used to form the first intermediate layer 120 on the surface of the base plate 100 by such a method as attaching a thick resist film, or spin-coating the novolac type photoresist.

6) exposing a portion for the flow channel 110 similarly by utilizing the photomask or the like and then developing the portion to eliminate it.

7) lastly, joining the cover 103 and the second intermediate layer 121 obtained in the step 3) to the base plate 100 and the first intermediate layer 120 obtained in the step 6) as shown in 7) of FIG. 4, and thereby the filter can be manufactured.

The filter of the first exemplary embodiment of the present invention can be realized by such simple process comprising the steps of applying and patterning the photosensitive molding materials, and then joining so that the manufacturing cost thereof can be significantly lowered in comparison with those of the conventional filters.

Next, a second exemplary embodiment of the filter of the present invention will be explained in detail with reference to the drawings.

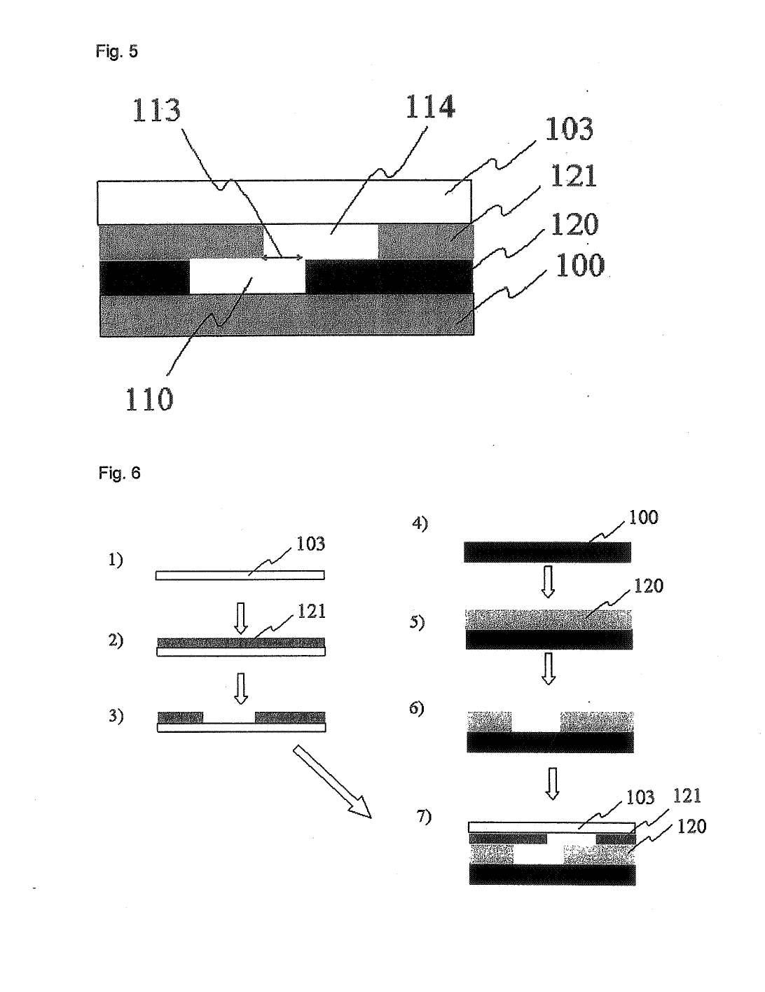

FIG. 5 is a sectional view showing the filter according to the second exemplary embodiment of the present invention.

The second exemplary embodiment of the present invention is different in that it uses a horizontal clearance 113 instead of the vertical clearance 112 of the first exemplary embodiment. In the first exemplary embodiment, the two flow channels 110 were formed in the first intermediate layer while one upper flow channel 114 was formed in the second intermediate layer. In the second exemplary embodiment, however, one flow channel 110 is formed in the first intermediate layer while one upper flow channel 114 is formed in the second intermediate layer 121.

The filtering function is realized by selecting the width of the horizontal clearance 113 connecting the flow channel 110 with the upper flow channel 114 according to the size of the subject to be filtered out. To be more specific, if the sample is introduced to the upper flow channel 114, the components larger than the horizontal clearance 113 remain in the upper flow channel 114, and the components smaller than the horizontal clearance 113 are taken out of the flow channel 110. It is also possible to introduce the sample to the flow channel 110 side and take out the separated components from the upper flow channel 114 by adjusting affinity for the solvent of the inner wall of the flow channel or utilizing a pump.

Whereas the vertical clearance 112 is formed with high accuracy by controlling the film thickness of the second intermediate layer, the horizontal clearance 113 of the second type filter is formed with high accuracy by controlling position alignment of the flow channel 110 and the upper flow channel 114. Unlike the first exemplary embodiment, the second exemplary embodiment has a merit that the implementation area of the filter can be smaller than that of the first exemplary embodiment, in addition to the merit that the thickness of the second intermediate layer 121 can be arbitrarily selected.

In the second exemplary embodiment of the present invention shown in FIG. 5, the filtering function thereof is attained by constituting the width (W3) of the horizontal clearance 113 connecting the flow channel 110 with the upper flow channel 114 so that the subject (large component) to be filtered out cannot pass. On the other hand, the soluble component and small component dissolved in the liquid component pass through the clearance having the width (W3) of the horizontal clearance 113 connecting the flow channel 110 with the upper flow channel 114 so as to migrate from the upper flow channel 114 to the flow channel 110 for instance. Therefore, the width (W3) of the horizontal clearance 113 connecting the flow channel 110 with the upper flow channel 114 is selected to satisfy at least L≧W≧T>W3 as to the overall size; L (length), W (width) and thickness (T) (provided L≧W≧T) of the subject (large component) to be filtered out. For instance, in the case where the subject (large component) to be filtered out is deformable like the red blood cell, it is desirable that the width (W3) of the horizontal clearance 113 be selected to satisfy L≧W≧T>S>W3 as to the minimum thickness (S) of the overall size after the deformation.

On the other hand, in the case of the configuration for allowing the liquid including the subject (large component) to be filtered out to pass through the upper flow channel 114, if the subject (large component) to be filtered out is deformable like the red blood cell, the vertical clearance 112;h equivalent to height of the upper flow channel 114 is selected to satisfy at least h≧S as to the minimum thickness (S) of the overall size after deformation thereof. It is also possible, for instance, to select the vertical clearance 112;h in the range of L≧W≧T>h>S so that the subject (large component) to be filtered out passes through the upper flow channel 114 in a partially deformed state. To be more specific, a magnitude relation between the width (W3) of the horizontal clearance 113 and the vertical clearance 112;h is selected to satisfy h≧S>W3.

The base plate 110, first intermediate layer 120, second intermediate layer 121 and cover 103 composing the second exemplary embodiment of the present invention can be realized by utilizing similar materials to those used in the first exemplary embodiment.

FIG. 6 show the steps of process for realizing the second exemplary embodiment. It is quite similar to that of the first exemplary embodiment except that position alignment accuracy of the flow channel 110 and the upper flow channel 114 is required. Although the position alignment accuracy of 0.1 μm or so is required, the position alignment accuracy is sufficiently realizable by a mask aligner provided as a standard to a general exposure apparatus. It is possible, by changing a joining position, to realize the filters having different horizontal clearances 113 by using the same mask. Therefore, the manufacturing cost can be lowered especially in the case of manufacturing various types of filters.

The present invention may also be the following exemplary embodiment.

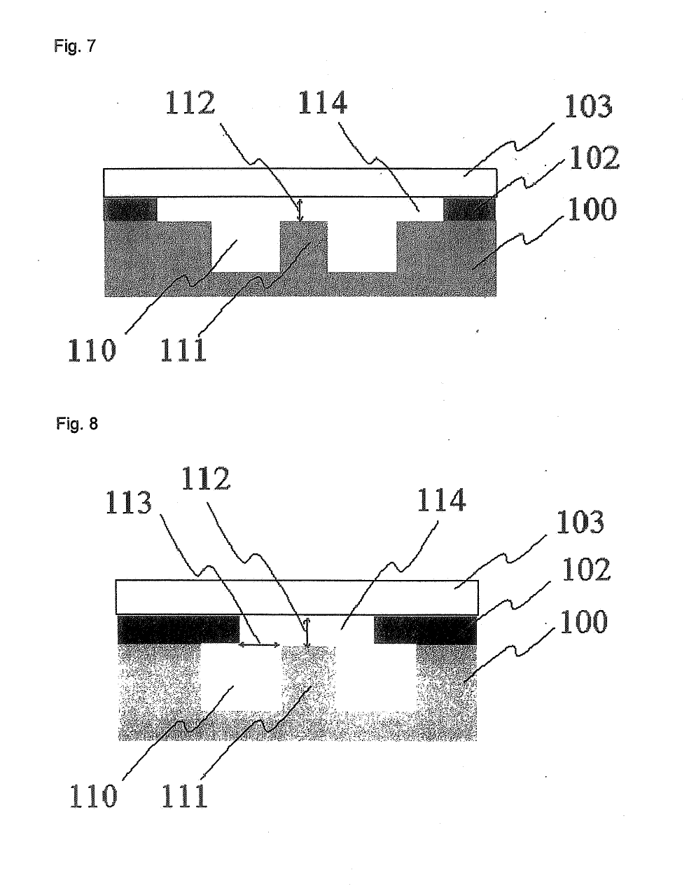

FIG. 7 is a sectional view showing a third exemplary embodiment of the present invention.

The third exemplary embodiment has a structure similar to that of the first exemplary embodiment. However, the third exemplary embodiment is different from the first exemplary embodiment in that it forms the width of the upper flow channel 114 to be wider than the widths of the two flow channels 110 and the barrier wall 111 put together.

For that reason, when joining the first intermediate layer 120 to the second intermediate layer 121, they can be joined with a sufficient margin. Therefore, there is a merit that the manufacturing can be performed at low cost by utilizing such relatively low-accuracy method of joining that joining them is made by aligning the base plate 100 and the cover 103 with their four corners just matching. The materials of the members used to realize it can be the same as those of the first exemplary embodiment. Even if the upper flow channel 114 is displaced slightly from the flow channel 110 portion, the volume of the clearance of the portion displaced from the flow channel 110 is negligible in comparison with the shape of the flow channel 110 (e.g. width: about 50 to 100 μm, depth: 20 to 50 μm) because the thickness of the second intermediate layer 121 is extremely thin (e.g. 1.8 μm in the case of the plasma separation). For instance, even if there is a displacement of 10 μm from the flow channel 110, a volume ratio is as low as 1/100 or so.

Furthermore, the third exemplary embodiment can be rendered as a fourth exemplary embodiment characterized by inversely providing the upper flow channel 114 of which width is smaller than the sum of the widths of the two flow channels 110 and the barrier wall.

In the third exemplary embodiment of the present invention shown in FIG. 7 as with the first exemplary embodiment of the present invention shown in FIG. 3, the filtering function thereof is attained by constituting the clearance between the upper end of the barrier wall 111 and the cover 103 so that the subject to be filtered out cannot pass. On the other hand, the soluble component dissolved in the liquid component passes through the third flow channel, that is, the clearance between the upper end of the barrier wall 111 and the cover 103 so as to migrate from the first flow channel to the second flow channel for instance. Therefore, it is desirable that the vertical clearance 112;h and the width (W2) of the upper end of the barrier wall 111 be selected within the same ranges as those of the first type. It is also desirable to select the material of the first intermediate layer 120 composing the upper end of the barrier wall 111 and the material composing the backside of the cover 103 according to the same criteria as those of the first type.

FIG. 8 is a sectional view showing the fourth exemplary embodiment of the present invention.

In the fourth exemplary embodiment, the filtering function is realized by two horizontal clearances 113 and one vertical clearance 112. Filter separation at least over two steps becomes possible by forming these three clearances with different widths.

For instance, when the sample contains a large-size component 1, an intermediate-size component 2 and a small-size component 3, it is possible to form the horizontal clearance 113 on the left side of FIG. 8 to be smaller than the component 1 and larger than the component 2, form the vertical clearance 112 larger than the component 2, and form the horizontal clearance 113 on the right side to be smaller than the component 2 and larger than the component 3. In the fourth exemplary embodiment thus formed, if the sample is introduced to the flow channel 110 on the left side of FIG. 8, the component 1 is mainly collected from the flow channel 110, the component 2 is mainly collected from the upper flow channel 114, and the component 3 is collected from the flow channel 110 on the right side. After supply of the sample is stopped, it is possible, by continuously introducing a buffer to the flow channel 110, to improve the ratio of the component 1 in the flow channel 110 on the left side, the ratio of the component 2 in the upper flow channel 114 and the ratio of the component 3 in the flow channel 110 on the right side.

It is also possible to provide multiple flow channels 110 in the third exemplary embodiment and form the upper flow channels 114 among the flow channels. In that case, multi-step filtration can be realized by selecting stepwise sizes of the plurality of the horizontal clearance 113 and vertical clearance 112.

It is further possible, in the first exemplary embodiment and the second exemplary embodiment, to use a plastic resin, such as an acrylic resin, polycarbonate, poly-ethyleneterephthalate, polystyrene or poly-dimethylsiloxane, as the material of the base plate 100 and form the flow channels 110 and the barrier wall 111 thereon by using a mold.

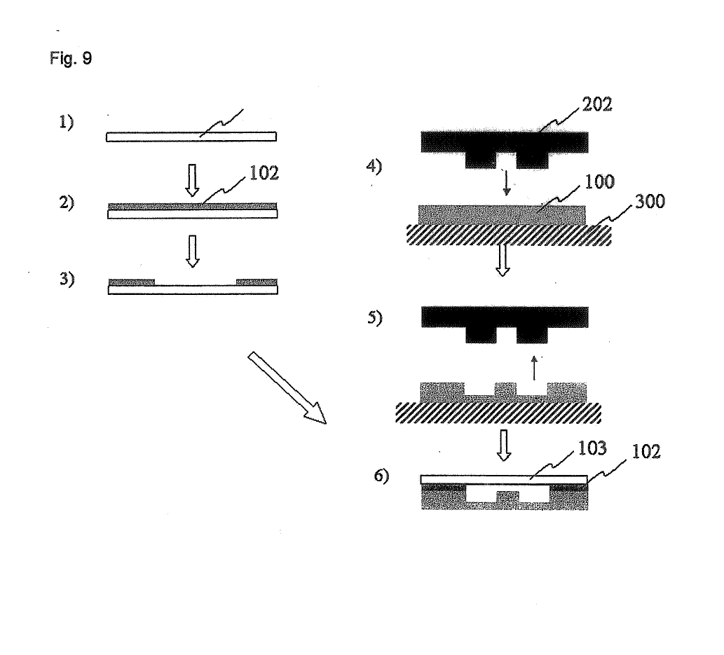

FIG. 9 are steps-flow drawings showing the processing method using the mold. The steps 4) and 5) are different from those of the first and second exemplary embodiments. In the step 4), a mold 202 used therein is prepared in advance by engraving a portion equivalent to the flow channels 110 on a metal of high toughness such as nickel into a convexity by utilizing a micro lathe or the like.

The base plate 100 is placed on a flat and smooth surface plate 300, heated up to a glass transition point and has the mold 202 pressed thereon while performing vacuuming as required.

In the step 5), the shape is stabilized by rendering the entirety equal to or below the glass transition point, and then the mold 202 is ripped up from the base plate 100. As a result, the base plate 100 having the flow channel 100 and the barrier wall 111 built therein is formed.

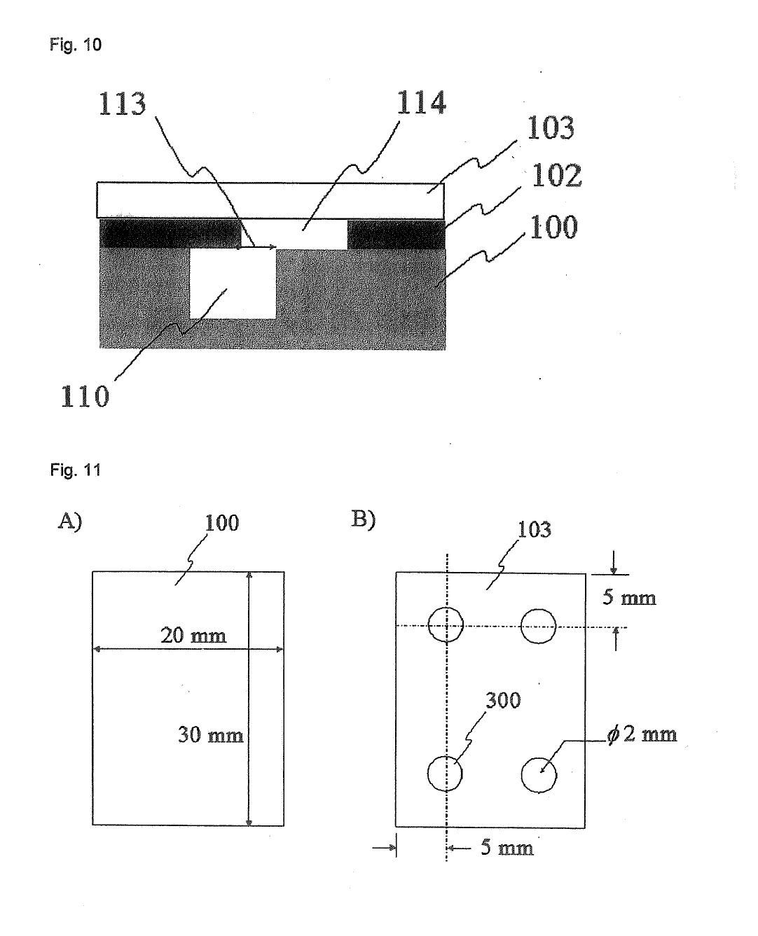

In the last step 6), the filter structure is realized by joining the cover 103 provided with the upper flow channel 114 thereon. It is also possible, in the process of FIG. 9, to change the mold shape and render the flow channels 110 as one so as to construct the filter similar to the second exemplary embodiment as shown in FIG. 10. It is possible, by utilizing the mold, to reduce the steps of treatment such as exposing, developing and cleaning and facilitate the processing for the flow channels 110 so as to allow the manufacturing cost to be further reduced.

### EXAMPLES

Next, an explanation will be made by taking a concrete exemplary embodiment as to the process for manufacturing a filter according to the first exemplary embodiment of the present invention.

Each step of the process for manufacturing the filter will be concretely explained with reference to FIGS. 3 and 4.

A Pyrex glass (Seiken Precision Glass Co., Ltd.) of 0.5-mm thickness and 10-cm diameter was used for the base plate 100, and a Pyrex glass of 0.2-mm thickness was similarly used for the cover 103, which were in advance processed in the shapes shown in FIG. 11. FIG. 11B) shows the shape of the cover 103. The cover 103 is provided with through-holes 300 of 2-mm diameter at four locations, which are used as the sample inlets in a completed filter to be used for introduction of the sample and buffer.

Both the base plate 100 and cover 103 underwent sulfuric-peroxide mixture (SPM) cleaning for 10 minutes and then water washing with ultrapure water for 5 minutes so as to be used (steps 1 and 4 of FIG. 4). The base plate 100 was set on a spin coater (IH-D2, Mikasa Co., Ltd.), and spin coating was performed with a coupling agent by giving a few drops of a silazane xylene solution on its surface to provide enhanced adhesiveness of the resist. The condition of 800 rpm/5 seconds and 4000 rpm/25 seconds was used in the spin coating for all the steps.

After coating with xylene-silazane, the novolac type photoresist (S1818, Rohm and Haas Electronic Materials Co., Ltd.) was spincoated as a first molding material for the first intermediate layer 120. After resist coat, it was pre-baked on a hot plate (Ultrahot Plate HI-400A, As One Corporation) warmed up to 80° C. for 30 seconds (step 5 of FIG. 4). A photomask was prepared, of which portions corresponding to the flow channels 110 and the other devices attached thereto (guiding flow channel 005, sample inlet 001 and liquid reservoirs 002 to 004) shown in FIG. 1 are optically transparent portions. Contact exposure was performed to a pre-baked resist material film on the surface of the base plate 100 by utilizing the photomask.

The exposed resist film was developed by a developing solution (Microposit MF CD-26 of Rohm and Haas Electronic Materials Co., Ltd.) containing TMAH as its component for 30 seconds. After the development, it was water-washed for 5 minutes, and was further post-baked by a baking furnace (inert oven DN 4101 of Yamato Scientific Co., Ltd.) at 120° C. for 120 minutes. As a result of this, the flow channels 110 and other devices attached thereto were formed in the first intermediate layer 120 (step 6 of FIG. 4). After spin-coating the cover 103 with a solution of mixture of xylene-silazane as with the base plate 100, the same photoresist as that used in the previous step was spin-coated as a second molding material for the second intermediate layer 121, and the pre-baked (step 2 of FIG. 4).

After pre-baking, the photoresist was exposed by using the photomask of which portion equivalent to the upper flow channel 114 is optically transparent portions, and then developed and water-washed, and was similarly post-baked at 120° C. for 120 minutes. As a result of this, the upper flow channel 114 was formed in the second intermediate layer 121 (step 3 of FIG. 4).

Lastly, the base plate 110 having the first intermediate layer 120 formed thereon, in which flow channel formation was finished, was set on a UV-ozone asher (PL-110D of Sen Light Corporation) with the surface of the first intermediate layer 120 up so as to perform an ashing treatment for 5 minutes. After this surface treatment, the cover 103 was placed on the surface of the first intermediate layer 120 with the second intermediate layer 121 down so as to perform sticking between the first intermediate layer 120 and the second intermediate layer 121. As the surface of the first intermediate layer was activated by the ashing treatment, there is consequently no need for an adhesive or the like. Strong and airtight adhesion was performed between the first intermediate layer and the second intermediate layer just by stacking and pressing them.

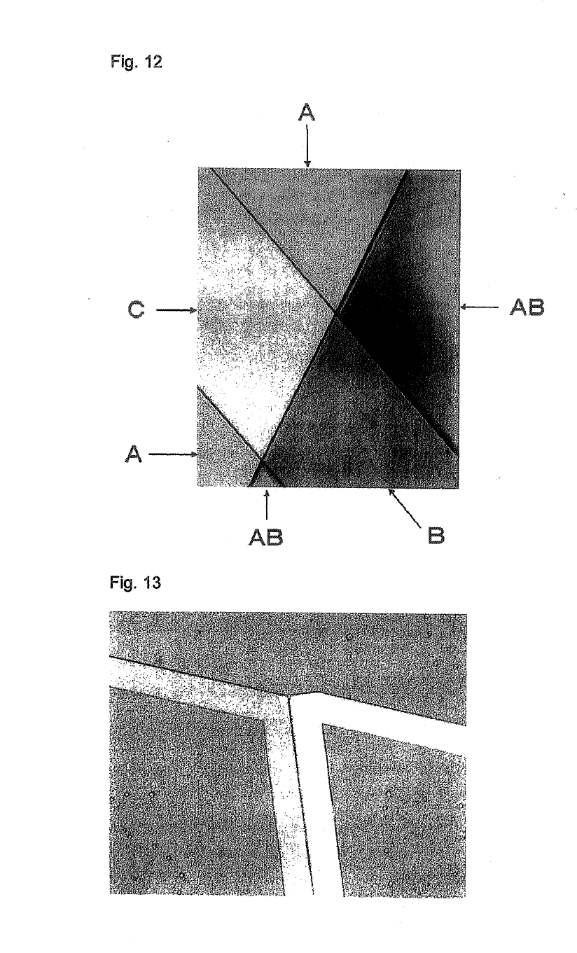

FIG. 12 is a microscopic image for illustrating the structure of the first exemplary embodiment according to the present invention, which was obtained from a prototype product in a preliminary experiment. The grooves composing the flow channels 110 were built in the first intermediate layer 120 formed on the base plate 100. The cover 103 is attached on that with the second intermediate layer 121 having an edge pattern formed thereon down.

The portion indicated by symbol A of FIG. 12 is a portion where the resist film layer composing the first intermediate layer 120 was formed on the base plate 100. The portion indicated by symbol C was a portion corresponding to the flow channels 110 formed in the first intermediate layer 120. The portion indicated by symbol AB was a portion where the resist film used for the first intermediate layer 120 and the resist film used for the second intermediate layer 121 were stuck up with each other. The portion indicated by symbol B is a portion where the grooves composing the flow channels 110 were covered with the resist film portion of the second intermediate layer 121, and thereby a cavity was formed between the grooves and the bottom of the resist film portion. This cavity portion was used as the flow channels 110.

The prototype product was broken apart, and the thicknesses of the first intermediate layer 120 and the second intermediate layer 121 were measured by a step gauge (Alpha-step of Tencor instruments) so as to compare them with their film thicknesses before the sticking. There was almost no change in the film thicknesses as to both the layers before and after the sticking. The results measured for different twelve positions were compared, and the film thicknesses after the sticking became thinner just by 8 nm at the maximum in comparison with the film thicknesses before the sticking. Therefore, it was judged that the processing accuracy required of the vertical clearance 112 corresponding to the thickness of the second intermediate layer 121 as well as reproducibility (100 nm) thereof was sufficiently attained by the process.

FIG. 13 is a microscopic image showing the result of introducing water to one of the flow channels of the first exemplary embodiment according to the present invention. When distilled water was introduced to the liquid reservoir on the left side which is corresponding to the liquid reservoir 003 of FIG. 1, the water automatically proceeded in the flow channels 110. However, it did not leak out to the flow channel on the other side by going over the barrier wall as with the conventional filter 006 described in Patent Document 1.

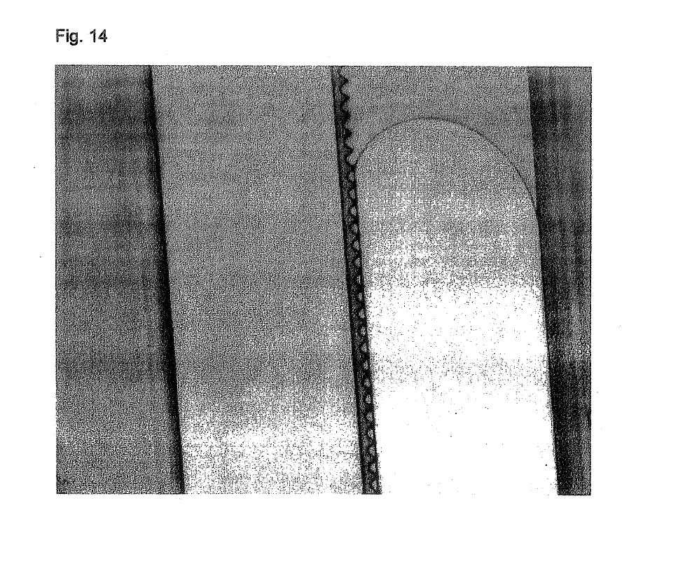

FIG. 14 shows a result of introducing water containing a slight amount of surfactant.

In the case of introducing the water containing the surfactant, the flow channel on the left side was filled, and then the water started to leak out to the other side after a while. Hence, it reveals that the vertical clearance 112 was formed in the barrier wall portion. It was understood that, as the surfactant was added, the surfactant covered the surface of the barrier wall portion so that a degree of hydrophobicity was reduced, and so the water leaked out from the first flow channel to the flow channel on the other side through the vertical clearance 112.

The chip of this exemplary embodiment showed the same result even after being left for two weeks. To be more specific, it indicates that, even after the manufacturing of the filter, there is little change in hydrophilicity and hydrophobicity of an inner surface of the flow channel of the filter according to the present invention, which shows that its storage stability is good.

### INDUSTRIAL APPLICABILITY

The filter according to the present invention is expected to be utilized in a wide range as a solid-liquid separation filter applicable to a process of separating soluble fractions from solid components, which is aimed at a sample liquid including the solid components, in a process of plasma separation in a clinical test or a refining process of the sample in a biochemical analysis.

1. A filter comprising:
a base plate;
a first intermediate layer;
a second intermediate layer; and
a cover,
wherein
the first intermediate layer has a first flow channel and a second flow channel with predetermined widths and depths;
the second intermediate layer has a third flow channel with a predetermined width and depth;
the third flow channel communicates with the first flow channel and with the second flow channel; and
the maximum depth of the third flow channel is smaller than the minimum depths of the first flow channel and the second flow channel.

2. The filter of claim 1,
wherein
the first flow channel and the second flow channel are placed to run side by side; and
the third flow channel is placed to run side by side with the first flow channel and the second flow channel which run side by side with each other.

3. The filter of claim 1,
wherein
either both or one of the first intermediate layer and the second intermediate layer is formed out of a photosensitive molding material selected from the group consisting of a photoresist, a photo-curing resin, photosensitive glass and photosensitive polyimide.

4. A filter comprising:
a base plate;
an intermediate layer; and
a cover,
wherein
the base plate has a first flow channel and a second flow channel with predetermined widths and depths;
the intermediate layer has a third flow channel with a predetermined width and depth;
the third flow channel communicates with the first flow channel and with the second flow channel; and
the maximum depth of the third flow channel is smaller than the minimum depths of the first flow channel and the second flow channel.

5. The filter of claim 4,
wherein
the first flow channel and the second flow channel are placed to run side by side; and
the third flow channel is placed to run side by side with the first flow channel and the second flow channel which run side by side with each other.

6. The filter of claim 4,
wherein
the intermediate layer is formed out of a photosensitive molding material selected from the group consisting of a photoresist, a photo-curing resin, photosensitive glass and photosensitive polyimide.

7. The filter as claimed in any one of claims 1 to 6,
wherein
the maximum width of a communicating portion of the third flow channel and the first flow channel is smaller than the minimum width of the first flow channel; and
the maximum width of the communicating portion of the third flow channel and the second flow channel is smaller than the minimum width of the second flow channel.

8. A chip comprising at least one filter as its component,
wherein the filter as claimed in any one of claims 1 to 7 is used as at least one or more of the filters.

9. An apparatus comprising at least one filter as its component,
wherein the filter as claimed in any one of claims 1 to 7 is used as at least one or more of the filters.

10. A filter comprising:
a base plate;
a first intermediate layer;
a second intermediate layer; and
a cover,
wherein:
the first intermediate layer has a first flow channel with a predetermined width and depth;
the second intermediate layer has a second flow channel with a predetermined width and depth;
the second flow channel communicates with the first flow channel; and
the maximum width of a communicating portion of the first flow channel and the second flow channel is smaller than the minimum width of
the first flow channel and is also smaller than the minimum width of the second flow channel.

11. The filter of claim 10,
wherein
the first flow channel and the second flow channel are placed to run side by side.

12. The filter of claim 10,
wherein
either both or one of the first intermediate layer and second intermediate layer is formed out of a photosensitive molding material selected from the group consisting of a photoresist, a photo-curing resin, photosensitive glass and photosensitive polyimide.

13. A filter comprising:
a base plate;
an intermediate layer; and
a cover,
wherein
the base plate has a first flow channel with a predetermined width and depth;
the intermediate layer has a second flow channel with a predetermined width and depth;
the second flow channel communicates with the first flow channel; and
the maximum width of a communicating portion of the first flow channel and the second flow channel is smaller than the minimum width of the first flow channel and is also smaller than the minimum width of the second flow channel.

14. The filter of claim 13,
wherein
the first flow channel and the second flow channel are placed to run side by side.

15. The filter of claim 13,
wherein
the intermediate layer is formed out of a photosensitive molding material selected from the group consisting of a photoresist, a photo-curing resin, photosensitive glass and photosensitive polyimide.

16. A chip comprising at least one filter as its component,
wherein the filter as claimed in any one of claims 10 to 15 is used as at least one or more of the filters.

17. An apparatus comprising at least one filter as its component,
wherein using the filter according to any one of claims 10 to 15 as at least one or more of the filters.

18. A method of manufacturing a filter composed of a base plate, a first intermediate layer made of a first molding material, a second intermediate layer made of a second molding material, and a cover, the method comprising the steps of:
applying the first molding material on the base plate;
forming a flow channel in the first molding material;
applying the second molding material on the cover;
forming the flow channel in the second molding material; and
joining a surface of the first molding material having the flow channel formed thereon to the surface of the second molding material having the flow channel formed thereon.

19. The method of manufacturing a filter according to claim 18,
wherein
in either both or one of the steps of forming the flow channel on the first molding material and of forming the flow channel on the second molding material,
a photosensitive molding material is employed as the first molding material or the second molding material, and
said step comprises the steps of exposing and developing the photosensitive molding material.

20. A method of manufacturing a filter composed of a base plate made of a plastic material, an intermediate layer made of a molding material, and a cover, the method comprising the steps of:
forming a flow channel on the base plate made of a plastic material by using a mold;
applying the molding material on the cover;
forming a flow channel on the molding material; and
joining a surface of the base plate having the flow channel formed thereon to the surface of the molding material having the flow channel formed thereon.

21. The method of manufacturing a filter according to claim 20,
wherein
in the step of forming a flow channel on the molding material,
a photosensitive molding material is employed as the molding material, and
the step comprises the steps of exposing and developing the photosensitive molding material.

22. The method of manufacturing a filter according to any one of claims 18 to 21,
wherein the step of joining comprises the steps of:
performing a surface treatment operation selected from the group consisting of UV-ozone ashing and oxygen plasma ashing to joined planes to be joined before joining them with each other so as to reform the surfaces of the planes to be joined; and
performing the joining by utilizing the reformed surfaces.
